(19) United States
(12) Patent Application Publication
(10) Pub. No.: US 2009/0043882 A1
(43) Pub. Date: Feb. 12, 2009

(54) Systems and methods for consolidated service level agreements

(76) Inventors: Jason S. Hibbets, Raleigh, NC (US); John R. Mattox, Raleigh, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/882,953

(22) Filed: Aug. 8, 2007

(51) Int. Cl. G06F 15/173

(52) U.S. Cl. 709/224

(57) ABSTRACT

An embodiment relates providing collaborative support for a service portal. The method includes providing a plurality of products on the service portal, where each product is associated with a respective vendor. The method also includes receiving a set of selection of products based on the plurality of products and determining a set of support resources for the set of selection of products. The method further includes applying a single service level agreement to the set of selection of products, where a first product is associated with a first vendor and a second product is associated with a second vendor.

### FIELD

This invention relates generally to technical support techniques, more particularly, to systems and methods for consolidated service level agreements.

### DESCRIPTION OF THE RELATED ART

The proliferation of the World Wide Web through the Internet has made a wealth of products and services available to users to purchase and use nearly instantaneously. Vendors, service providers, manufacturers, third party distributors, etc., may have web sites for the users to review and purchase their respective products and/or services.

As users purchase products and/or services from conventional web sites, the users may require technical assistance for the purchased products and/or services. Technical assistance may be needed for variety of issues such as installation, configuration, bugs, hardware failure, etc. Although the user may have purchased the product(s) and/or service(s) with technical support, each product and/or service may have a different vendor especially for web-sites acting as a distributor for a variety of vendors. Accordingly, a user may be required to contact the associated help desk of the vendor to resolve the issue.

For users implementing multiple products and/or services, this conventional method of resolving issues can become daunting. For example, if a user has an application stack that includes an operating system from vendor one, an electronic mail program from vendor two, and a database program from vendor three, an error occurring in the database program can be blamed on the operating system. Accordingly, the user may have to contact vendor one to resolve issue only to find out that vendor one may point the error back at the database program. Thus, there is a need in the art for a mechanism where users can direct technical issues for a variety of products and/or services at a single point.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary system in accordance with an embodiment;

FIG. 2 illustrates an exemplary service portal of the system shown in FIG. 1 in accordance with another embodiment;

FIG. 3 depicts an exemplary consolidated help desk shown in FIG. 1 in accordance with yet another embodiment;

FIG. 4 illustrates an exemplary log-in flow diagram in accordance with yet another embodiment;

FIG. 5 depicts an exemplary issue submission flow diagram in accordance with yet another embodiment;

FIG. 6 illustrates an exemplary update flow diagram executed by the entitlement manager module in accordance with yet another embodiment;

FIG. 7A depicts an exemplary auto-escalation flow diagram in accordance with yet another embodiment;

FIG. 7B depicts an exemplary customer escalation flow diagram in accordance with yet another embodiment;

FIG. 7C illustrates an exemplary service agent escalation flow diagram in accordance with yet another embodiment;

FIG. 8A depicts an exemplary auto-resolution flow diagram in accordance with yet another embodiment;

FIG. 8B illustrates an exemplary customer and service agent resolution flow diagram in accordance with yet another embodiment; and

FIG. 9 depicts an exemplary computing platform in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information and service portals, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments pertain generally to systems and methods for providing a centralized customer support in a service portal. More particularly, a consolidated help desk can provide a single point of access for customers or users to obtain assistance. When a customer buys a product and/or service or a selection of products and/or services from the service portal, the purchased products and/or services are under a single or consolidated service level agreement (“SLA”). The consolidated SLA can provide a single point-of-contact for technical support for the purchased products and/or services. Unlike the conventional scenario where a user has to contact each vendor of a purchased product, the service portal can provide a consolidated help desk where a user can contact a service agent (technician, engineer, etc.) for any technical issue (installation, configuration, new feature, bug fix, etc.), i.e., the customer never has to deal with the original vendor of the selected product(s).

The consolidated SLA can also provide for service times and service requirements depending on an entitlement status of the user. The entitlement status can range from a first level where a user can only be provided access to a knowledge library to a highest level where a user can have the vendor and the service agent attempt to resolve the technical issue.

As part of the consolidated SLA, the service portal and the vendors that supply products and services to the service portal can form a collaborative federation to support the requirements of the consolidated SLA. More particularly, the vendors can agree to train the service agents of the service portal regarding their respective products and/or services. Accordingly, the service agents of the service portal can attempt to resolve any technical issue. However, if the service agents can not resolve the technical issue regarding the product of the vendor, the assigned service agent can collaborate with a technical support engineer of the respective vendor (or vendor service agent) to resolve the issue.

In some embodiments, the consolidated help desk can include a help manager module configured to enforce the service times and requirements of the consolidated SLA as well as provide a mechanism to support the collaborative federation. More particularly, the help manager module can be configured to interface with a knowledgebase, a web-ticketing system, a chat server, and a vendor database.

The knowledge library or knowledgebase can comprise of a Wiki-style database that allows articles to be rated and commented on by registered users and viewable by all users. The content within the knowledgebase can be articles in a question and answer format. The knowledgebase can also include a forum where registered and unregistered users can attempt to receive help from the user community of the service portal.

The web-ticketing system can be configured to provide a service agent a mechanism to manage and track issues from a user as well as to enforce the service times and service requirements as directed by the help manager module.

The chat server can be configured to allow users to interact with the service technician if the user is entitled based on the service level agreement. The chat server can also be used by the support engineer and a representative or agent of a vendor to resolve technical issues.

The vendor database can contain the contact information for each agent of the vendors supported by the service portal. Accordingly, the help manager module can query the vendor database to obtain the contact information of vendor agent in the event that a ticket requires assistance from the vendor and the consolidated SLA.

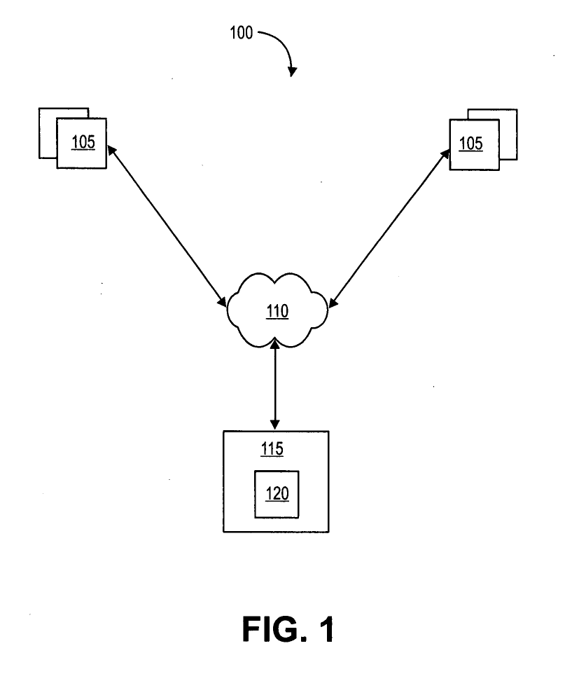

FIG. 1 illustrates an exemplary system 100 in accordance with an embodiment. It should be readily apparent to those of ordinary skill in the art that the system 100 depicted in FIG. 1 represents a generalized schematic illustration and that other components may be added or existing components may be removed or modified. Moreover, the system 100 may be implemented using software components, hardware components, or combinations thereof.

As shown in FIG. 1, the system 100 includes users 105, a network 110 and a service portal 115. The users 105 can be private individuals, employees of private business or public entities or other persons interested in accessing the service portal 115. The users 105 can access the service portal, 115 using personal computers, personal mobile devices, workstations or other networked computing platforms.

The network 110 can be a combination of wide area and local area networks such as the Internet. The network 110 can be configured to provide a communication channel between the users 105 and the service portal 115. The network 110 can implement a variety of network protocols to provide the communication channel such as Internet Protocol (“IP”) Vx, ATM, SONET, or other similar network protocols.

The service portal 115 can be configured to provide products and services to the user 105 as well as provisioning, installation services, updates to software and hardware products and technical support. The service portal 115 can, among other functions, provide a list of products such as software applications and/or hardware devices as well as services such as installation, configuration, maintenance, etc., for users to purchase. As a non-limiting example, the service portal 115 can also provide information for users to research, compare and purchase software, hardware and consulting services in support of those software and/or hardware purchases. The service portal 115 can also be configured to provide support services by subscription to those same software, service, and/or hardware purchases.

In accordance with various embodiments, the service portal 115 can be configured to provide a single point of contact help desk support by a collaborative federation of service agents of the service portal 115 and vendors by a consolidated help desk 120. More specifically, the consolidated help desk 120 can provide a mechanism to enforce the consolidated SLA and provide the collaborative federation team of service agents and vendor service agents. The consolidated help desk 120 can instantiate a ticket for a received technical issue and assign a first available service agent to the ticket. The consolidated help desk 120 can also perform an entitlement check to determine the level of service that the sender of the technical issue is entitled from a basic level to a full level. In the event that the technical issue has to be elevated to a level that involves the collaborative federation, the consolidated help desk 120 can initiate the contact from the service agent to the respective vendor service agent.

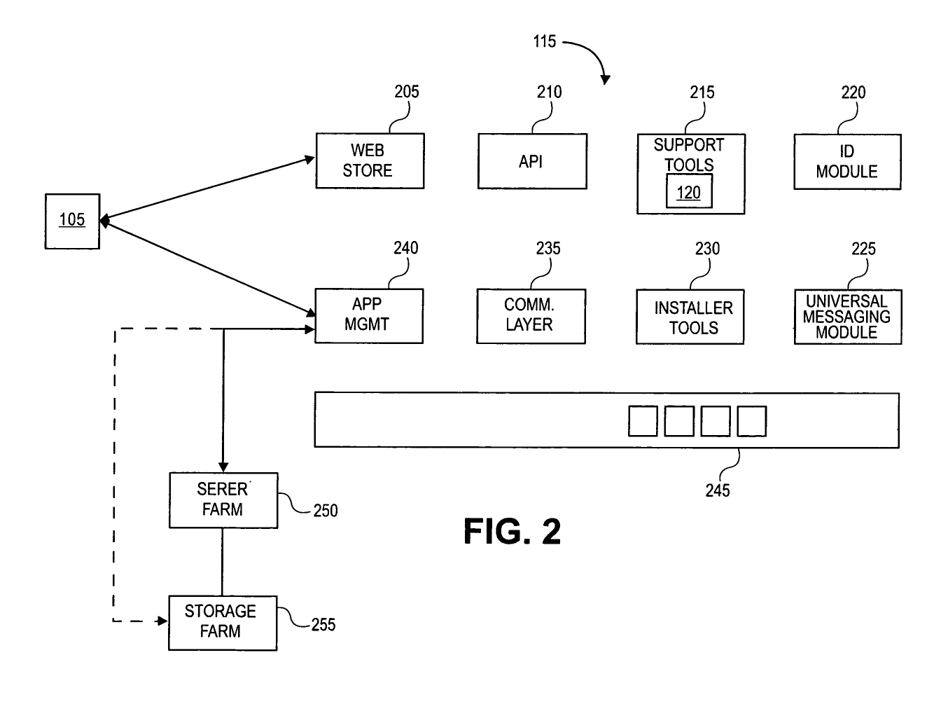

FIG. 2 illustrates a more detailed block diagram of the service portal 115 in accordance with another embodiment. It should be readily apparent to those of ordinary skill in the art that the service portal 1115 depicted in FIG. 2 represents a generalized schematic illustration and that other components may be added or existing components may be removed or modified.

As shown in FIG. 2, the service portal 115 can include a web store module 205 that a user can interface with the service portal. The web store module 205 can provide the graphical user interfaces (“GUIs”) and associated functions and/or services for the service portal 115. As an non-limiting example, the web store module 205 can generate a log-in GUI for a user to authenticate and enter the service portal 115.

The web store module 205 can couple with an application program interface (“API”) module 210. The API module 210 can be configured to provide an interface between the functions and/or services provided by the web store module 205 and to the appropriate module of the service portal 115. More particularly, the API module 210 can call or direct a requested function or service from the user to the respective module that provides that requested function or service. For example, a user may request a price of a product, e.g., an electronic mail program, the API module 210 can direct the request to a get price function in a support tools module 215.

The API module 210 can also be configured to interface with the support tools module 215. The support tools module 215 can be configured to provide the supporting software and hardware to implement the functionality of the service portal 115. The support tools module 215 can contain and provide access to databases that contain information such as products lines, services providers, on-line self-help (e.g., knowledgebase), etc. The support tools module 215 can also provide services like a chat services, a help desk, installation, provisioning, etc.

The API module 210 can be further configured to couple with an identification (“ID”) module 220. The ID module 220 can be configured to provide identification management services for the service portal 115. The ID module 220 can also store information related to users such as purchase history, user profile, usage history of the user, and entitlement data.

The API module 210 can be further configured to couple with a universal messaging module 225. The universal messaging module 225 can be configured to provide a messaging application that unifies messages. More specifically, electronic mail (“email”), documents, and instant messaging can be linked in a single application. The universal messaging module 225 can also provide a mechanism for a user to view all the related documents for the user from email to Wiki pages.

An installer tools 230 can be coupled to the API module 210. One of the services provided by the service portal 115 can be the purchase of software applications provided by independent software vendors (“ISVs”). As part of the delivery of the software applications, the ISV can be required to maintain and update the installation tools to install their respective software applications. Accordingly, the installer tools 230 can be a repository where independent software vendors can deposit their respective installation tools.

The API module 210 can be further coupled to the communication layer 235 (labeled as COMM layer in FIG. 2). The COMM layer 235 can be configured to provide the underlying services for the modules of the service portal 115 to communicate. For example, the COMM layer 235 can contain middleware for a product database to communicate with a graphical user interface requesting product description.

The API module 210 can be further coupled to an application management module 240 (labeled as APP MGMT in FIG. 2). The application management module 240 can be configured to manage applications as requested by users. More specifically, a user may purchase a prepackaged software application pack (e.g., an operating system, electronic mail program and data mining program) from the service portal 115, which is stored in an application stack module 245. The application management module 240 can then deliver the purchased software stack, install and configure the software application stack at a third party site such as server farm 250 or store the software application stack in a storage farm 255 for the user to retrieve.

The server farm 250 can be configured to provide computing platforms for users to lease. Accordingly, users can have a backup version of their systems, a testing platform to perform quality assurance tests on new applications, execute a program requiring excess MIPS, or any other similar computing task.

The storage farm 255 can be configured to provide storage space for users to lease. Accordingly, users can lease disk storage space to back up data, provide a hot data swap, or other storage intensive tasks.

In some embodiments, the consolidated help desk 120 can be configured to be executed in the support tools module 215. In other embodiments, the consolidated help desk 120 can be a module of the ID module 220. In yet other embodiments, the consolidated help desk 120 can be executed as a standalone module.

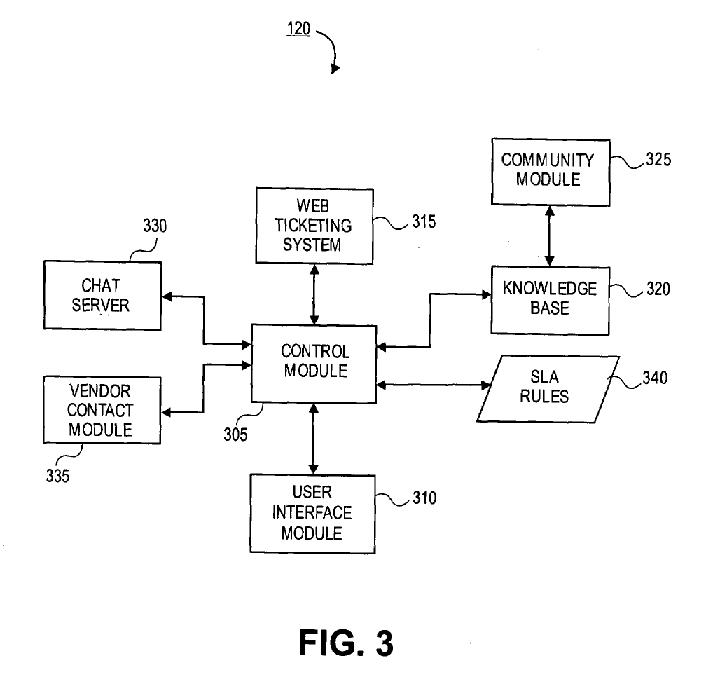

FIG. 3 depicts a more detailed block diagram of the consolidated help desk 120 in accordance with another embodiment. It should be readily apparent to those of ordinary skill in the art that the consolidated help desk 120 depicted in FIG. 3 represents a generalized schematic illustration and that other components may be added or existing components may be removed or modified.

As shown in FIG. 3, the consolidated help desk 120 can comprise a control module 305, a user interface module 310, a web ticketing system 315, a knowledge base 320, a community module 325, a chat server 330, a vendor contact module 335, and a SLA rules module 340. It should be readily obvious to one of ordinary skill in the art that the modules 305-340 can be implemented as software applications (programmed in C, C++, JAVA, PHP, etc.), hardware components (EEPROM, application specific integrated circuit, microprocessor, etc.) or combinations thereof.

The control module 305 can be configured to manage and interface with the other modules 310-340 to provide the functionality of the consolidated help desk 120 as described above and further described herein below.

The user interface module 310 can be configured to generate graphical user interfaces (“GUIs”) as required by the control module 305. For example, the user interface module 310 can generate a reminder GUI to remind a service agent to perform a status update on an issue ticket. The reminder GUI can be configured to pop up-on the computing platform (workstation, personal computer, laptop, personal digital assistant, etc.) or a link to the reminder GUI can be sent in an electronic message (electronic mail, text message, instant messaging, etc.). In some embodiments, the user interface module 310 can be considered an application program interface module which provides the necessary tools and interfaces to communicate with other modules of the consolidated help desk 120 and the other modules of the service portal 115.

The control module 305 can also be coupled to the web ticketing system 315. The web ticketing system 315 can comprise a case management system that is a web-based system that provides a mechanism to track technical issues from first reporting to final resolution. Case management systems are generally well known systems such as Numara Help Desk™, Sinergia Help Desk™, Issue Tracker, etc.

The web ticketing system 315 can be configured to provide a communication channel for the control module 305 to enforce SLA service requirements and times on a service agent as well as escalating issues to the collaborative federation between the service agents and vendors (or vendor service agents).

The control module 305 can also be coupled to the knowledge library or knowledgebase 320. The knowledgebase 320 can comprise of a Wiki-style database that allows articles to be rated and commented on by registered users and viewable by all users. The content within the knowledgebase can be articles in a question and answer format in some embodiments. Other formats can also be implemented in the knowledgebase 320 such as frequently asked questions, articles, etc. Coupled with the knowledgebase 320 can be the community module 325. The community module 325 can be implemented as a forum for registered and unregistered users to receive technical assistance from the user community of the service portal 115.

The control module 305 can be further coupled to the chat server 330. The chat server 330 can be configured to provide chat and instant messaging services for the service portal 115. An example, but not limited to, the chat server 330 can provide entitled users to contact a service agent of the service portal to communicate and attempt to resolve technical issues. The chat server 330 can also provide services between the service agents and the vendor service agents to collaborate on resolving technical issues that have been escalated to the highest severity levels or as required by the SLA requirements.

The vendor contact module 335 can provide a mechanism to contact the appropriate vendor service agent for a respective product and/or service for the control module 305. More particularly, the SLA provides, among other things, that the service agent become the owner of the technical issue from first reporting to final resolution. As part of the ownership, the service agent may be required to collaborate with an appropriate vendor service agent to resolve an issue. The vendor contact module 335 can provide the list of vendor service agents as well as mechanism to contact the appropriate vendor service agent for a particular issue.

The control module 305 can yet further be coupled to the SLA rules 340. The SLA rules 340 can store the SLA requirements for a service agent to respond to a technical issue depending on the entitlement status of a user. The SLA rules 340 can specify that the initial response time for any issue submitted to the consolidated help desk 120 is one business day. The response can include a confirmation that the issue has been received and that the service agent assigned is investigating or needs additional information from the reporting user.

The SLA rules 340 can also specify severity levels and support levels. The severity level can be classified as: level one being catastrophic production problems which severely impacts user's production systems or in which user production systems are down or not functioning; loss of production data and no procedural work around exists. Severity one problems can also include security breaches. Severity level two can be classified as a high impact problem in which user's operation is disrupted but there is capacity to remain productive and maintain necessary business-level operations. Severity level three can be described as medium-to-low impact which involves partial non-critical functionality loss impairing some operations but allowing user to continue to function. This severity level can include documentation errors. Finally, severity level four can be classified as general usage questions, recommendations for future product enhancements or modifications.

The support levels of the SLA rules 340 can be level zero, level one, level two and level three. Level zero support can be classified as the initial response provided by the service portal to user initiated request for assistance. Level zero support can comprise of logging of suspected problems, recording details of the issue in the web-ticketing system, dispatching support as detailed above and herein below, and managing the user request to an acceptable closure.

Level one support can be described as a first point of contact for a user that provides support, confirms post warranty or service contract, provides basic troubleshooting, and provides solution or dispatch. Level two support can mean the escalation point for level one support. Level two support provides support for issues that require in-depth research and/or troubleshooting. Level three support can be classified as a category of problems reported that after initial analysis of the vendor service agent is determined to most likely to be the result of a design defect with the vendor product or service or the result of a complex interaction that requires a bug fix.

The SLA rules 340 can further specify, for issues requiring additional help from vendor service agents, the rules of escalation the issue to the appropriate vendor service agent. For example, one escalation process can include an initial response time escalation by the service agent to initiate an escalation if the vendor service agent does not respond within a predetermined amount of time. A second escalation process can be an incident resolution escalation by a service agent or vendor service agent to initiate an escalation if the collaborative federation of service agents and vendor service agents do not respond or perform within the predetermined resolution time.

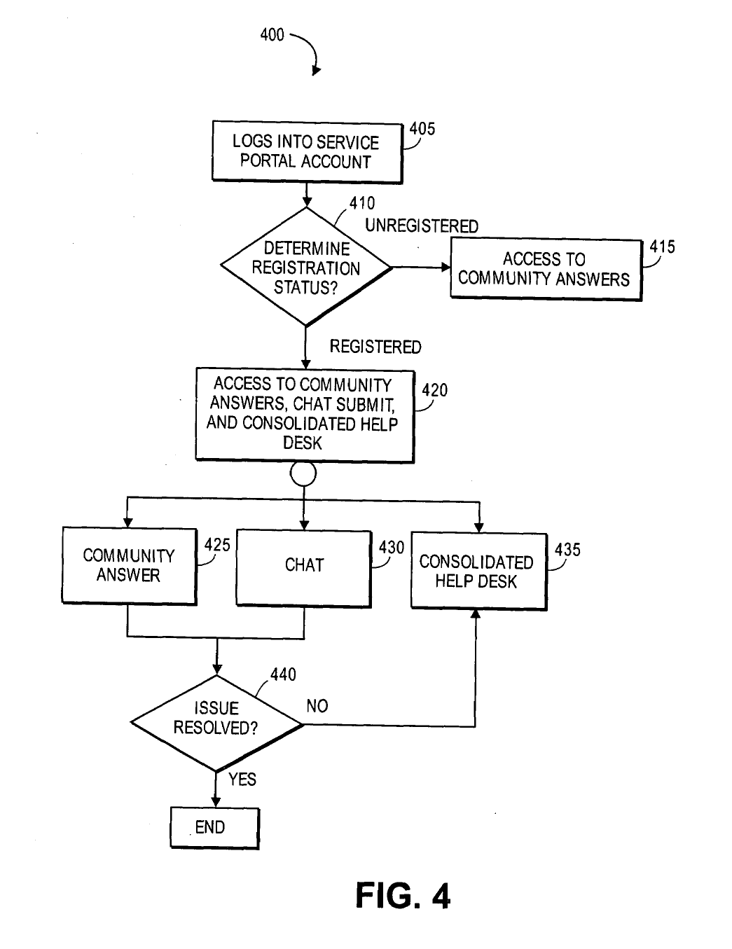

FIG. 4 illustrates a log-in flow diagram 400 in accordance with yet another embodiment. It should be readily apparent to those of ordinary skill in the art that the flow diagram 400 depicted in FIG. 4 represents a generalized schematic illustration and that other steps may be added or existing steps may be removed or modified.

As shown in FIG. 4, a user can log into the service portal 115, in step 405. More particularly, the web store 205 can generate a log-in graphical user interface (GUI) for users to log into the service portal. After the user enters a username and a password, the web store 205 can authenticate the user and allow access to the service portal 115. The web store 205 can then generate a home page, which, among other things, display a link to the technical assistance services.

When the user activates the link to the technical assistance services, web store 205 can direct the user to consolidated help desk 120, in step 410. The control module 305 can receive the entitlement status of the user from the web store 205 as part of the redirection. The entitlement status (non-registered, registered, basic, full, etc.) can determine what type of help services the user can access. For example, if the user has an entitlement status of non-registered, the user can only access the community answer forum implemented by the community module 325 for technical assistance, in step 415.

Otherwise, if the user has the appropriate entitlement status, the user can access the community answer forum, a chat submit service and a live support desk, in step 420. More particularly, the control module 305 can generate a help home page GUI that displays, among other things, a list of technical assistance options. The community answer forum, a chat submit service, and a live support can be on the list of technical assistance.

If a user selects the community answer forum, the user can be directed to the community answer forum implemented by the community module 325, in step 425. Within the community answer forum, the user can search for answers for his technical issue. The user can also post his technical issue within the community answer forum and request assistance from the user community.

If the user selects the chat submit service, the user can be directed to the chat service implemented by the chat server 330, in step 430. More particularly, the control module 305 can invoke the chat server to initiate a chat session between a user and a first available service agent of the service portal.

If the user selects the service agent support option, the user can be directed to a service agent support GUI generated by the user interface module 310, in step 435. More particularly, the service agent support GUI can provide a widget for a user to type in a description of the technical issue as well as user contact information. The control module 305 can be configured to supplement any user contact information with entitlement status or additional information from the user profile of the user.

In step 440, the user can determine whether or not the issue has been resolved. More specifically, as the user exits from either the community answer forum or the chat service, the control module 305 can invoke the user interface module 310 to generate an issue resolved GUI for the user to select. If the issue was resolved by either the community module 325 or the chat server 330, the control module 305 can return the user to the home page of the web store 205, in step 445. Otherwise, if the issue has not been resolved to the satisfaction of the user, the control module 305 can direct the user to service agent support option, in step 435.

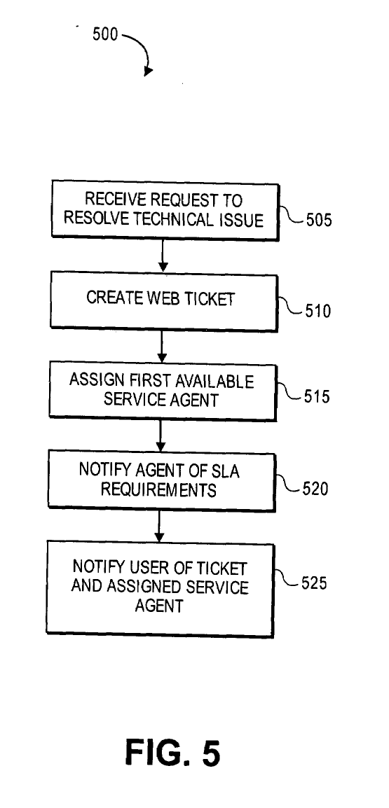

FIG. 5 illustrates an issue submission flow diagram 500 in accordance with yet another embodiment. As shown in FIG. 5, the control module 305 can receive a request to resolve an issue or problem from a user, in step 505. More particularly, the user may have been directed to the service agent support option from the list of technical assistance options as previously described.

In step 510, the control module 305 can forward the receive request for technical assistance to the web ticketing system 315. The control module 305 can also be configured to forward the SLA requirements for the user based on the entitlement status of the user. The web ticketing system 315 can be configured to create a web ticket to track and manage the technical issue in step 510.

In step 515, the web ticketing system 315 can be configured to assign the instantiated web ticket to the first available service agent. The web ticketing system 315 can notify the assigned service agent of the web ticket and the SLA requirements of the user, in step 520. The web ticketing system 315 can be configured to set the predetermined timer to resolve the web ticket according to the SLA rules 340.

In step 525, the web ticketing system 315 can be configured to notify the user of the web ticket and the assigned service agent. The assigned service agent has the responsibility to resolve the issue within the requirements of the SLA.

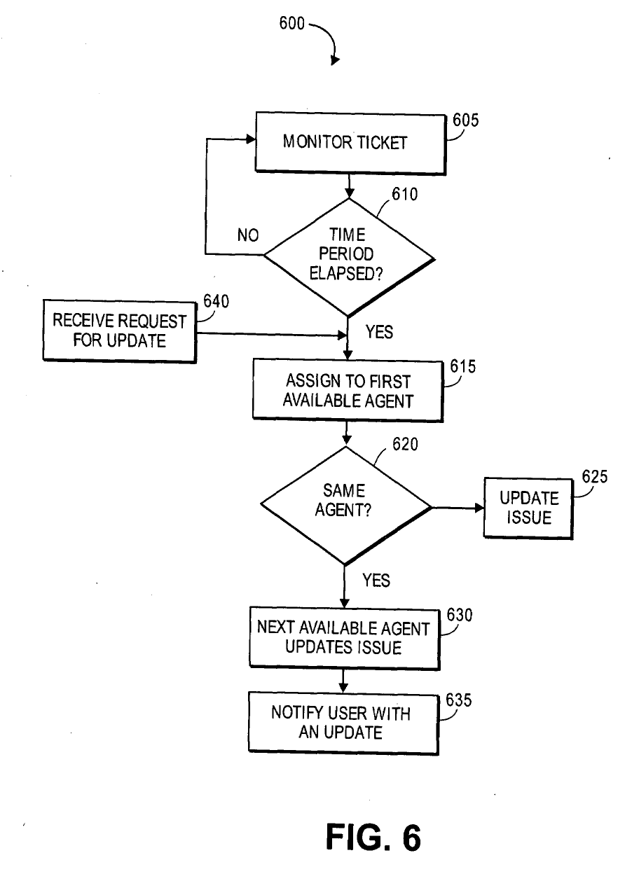

FIG. 6 illustrates an update flow diagram 600 executed by the web ticketing system 315 in accordance with yet another embodiment. As depicted in FIG. 6, the web ticketing system 315 can be configured to monitor the status of the web ticket, in step 605. More particularly, the web ticketing system 315 can maintain a queue or buffer of outstanding web tickets. The web ticketing system 315 can periodically check the status of each web ticket to ensure that the issues are being resolved according to SLA requirements.

Accordingly, in step 610, the web ticketing system 315 can determine whether the web ticket is within the predetermined requirements of the SLA rules module 340. If the web ticket is within the prescribed requirements, the web ticket is returned to the queue and processing proceeds to step 605.

Otherwise, if the web ticket exceeds a predetermined requirement such as responding within one business day, the web ticketing system 315 can be configured to assign the first available service agent to the web ticket, in step 615.

The web ticketing system 315 can be configured to determine whether the assigned service agent is the same service agent assigned to the original web ticket, in step 620. If the assigned service agent is the same service agent, the web ticketing system 315 can be configured to notify the service agent to update the web ticket and the user with a status, in step 625.

Otherwise, if the assigned service agent is not the original assigned service agent, the web ticketing system 315 can be configured to notify the assigned service agent to update the status of the web ticket, in step 630. Subsequently, the web ticketing system 315 can forward the updated status of the web ticket to the user, in step 635.

In various embodiments, a user can request an update in step 640. More particularly, the user can request an update through the aforementioned help desk home GUI, which may contain a link to request an update. Subsequently, the request is forwarded to the web ticketing system 315 and directed to the processing associated with step 615.

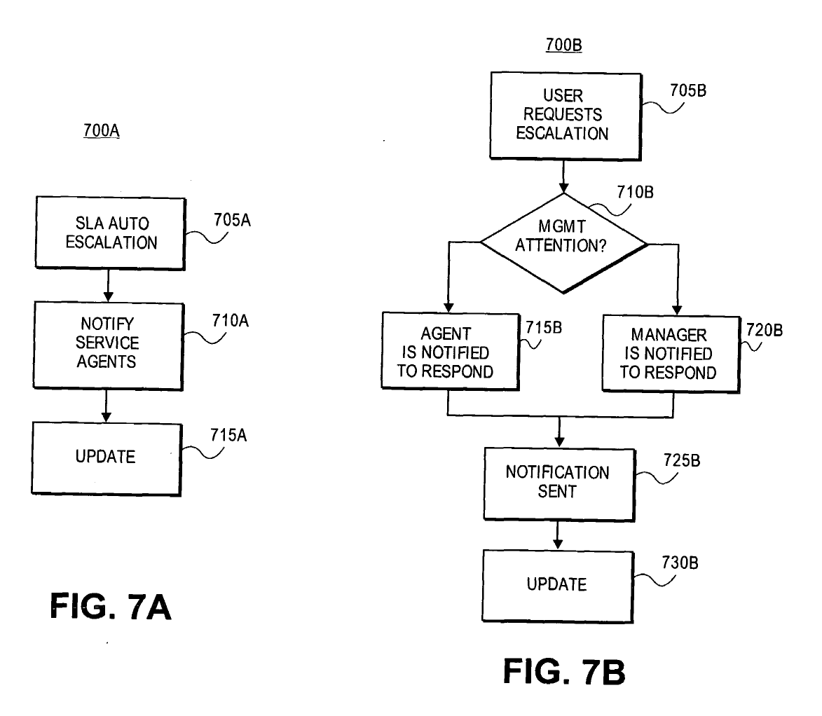

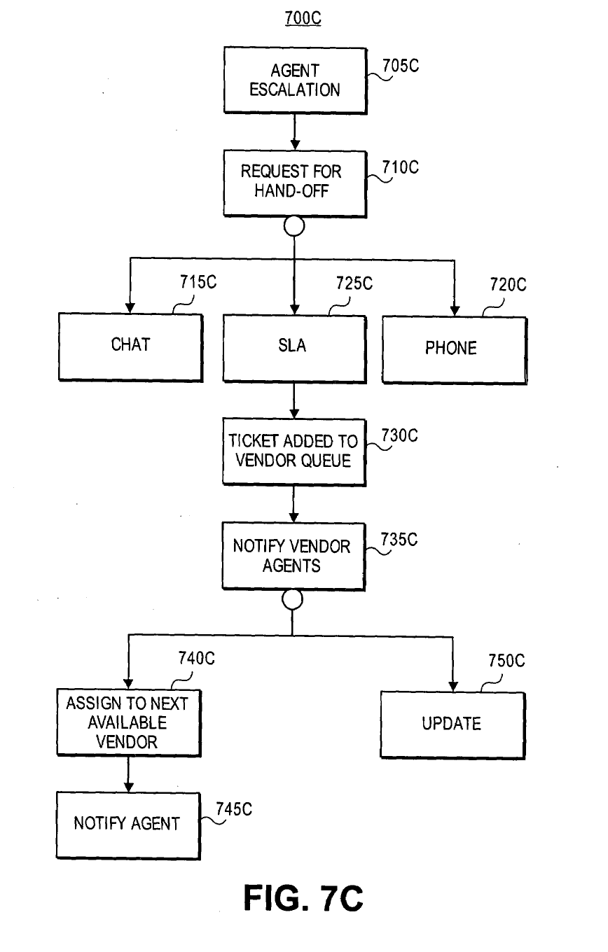

FIG. 7A illustrates an auto escalation flow diagram 700A executed by the web ticketing system 315 in accordance with yet another embodiment. It should be readily apparent to those of ordinary skill in the art that the update flow diagram 700A depicted in FIG. 7A represents a generalized schematic illustration and that other steps may be added or existing steps may be removed or modified.

As shown in FIG. 7A, the web ticketing system 315 can be configured to escalate a web ticket to the vendor service agent, in step 705A. As previously described, the web ticketing system 315 can maintain a queue or buffer of outstanding web tickets. The web ticketing system 315 can periodically check the status of each web ticket to ensure that the issues are being resolved according to SLA requirements. If the queued web ticket exceeds a predetermined threshold (for example, inactivity for three weeks), the web ticketing system 315 can be configured to escalate the queued web ticket to the vendor service agent.

In step 710A, the web ticketing system 315 can notify the assigned service agent of the escalation. The web ticketing system 315 can then implement the update flow diagram 600 shown in FIG. 6 to update the status of the escalation of the web ticket, in step 715A.

FIG. 7B illustrates a customer escalation flow diagram 700B executed by the web ticketing system 315 in accordance with yet another embodiment. As shown in FIG. 7B, the user can request an escalation, in step 705B. More specifically, the user can access the help desk home page GUI which can contain a link to escalate an existing web ticket.

When the user activates the link, the web ticketing system 315 can be configured to determine whether the queued web ticket requires management attention, in step 710B. More particularly, a manager requested GUI can be generated by the user interface module 310 for a user to select whether the technical issue of the user needs management attention. For example, the manager requested GUI can contain a widget that when activated can contact a management representative.

If the escalation does not require management attention, the web ticketing system 315 can be configured to notify the assigned service agent to respond to the escalation request, in step 715B. If escalation does require management attention, the web ticketing system 315 can be configured to notify a first available manager, in step 720B.

In step 725B, the first available manager or the assigned service agent can transmit a message to the user that the escalation request has been received and is being processed. Subsequently, the web ticketing system 315 can implement the flow diagram 600 shown in FIG. 6 to update the status of the escalation by the user.

FIG. 7C depicts an exemplary service agent escalation flow diagram 700C in accordance with yet another embodiment. As shown in FIG. 7C, the service agent can initiate an escalation of a technical issue described in a web ticket, in step 705C. More particularly, the service agent may have conducted research to resolve an issue but did not find an answer using the resources of the service portal 115 (knowledgebase, other service agents, etc.).

The service agent can then attempt a hand-off to the vendor service agent, in step 710C. More specifically, the service agent can attempt to contact the respective vendor service agent by chat service, telephone or automatically.

In step 715C, the service agent can set up a chat session with the vendor service agent in attempt to resolve the issue.

In step 720C, the service agent can attempt to contact the vendor service agent by telephone to resolve the technical issue. However, this method is preferred for issues with higher severity. Subsequently, the first available vendor service agent can respond, in step 730C. By agreement with the collaborative federation between the service portal and the vendors, the responding service agent becomes the owner of the technical issue, in step 735C.

In step 740C, the vendor service agent can send a notification of the assigned vendor service agent to the web ticketing system 315 and is updated in the web ticketing according to the update flow diagram as depicted in FIG. 6.

Returning to step 725C, the service agent can escalate the technical issue through the web ticketing system 315. The web ticketing system 315 can be configured to submit the web ticket associated with the technical issue to the case management system of the appropriate vendor service agent, in step 745C. The vendor case management system can notify the vendor service agent of the incoming ticket and proceeds with the processing associated with step 730C and the following steps.

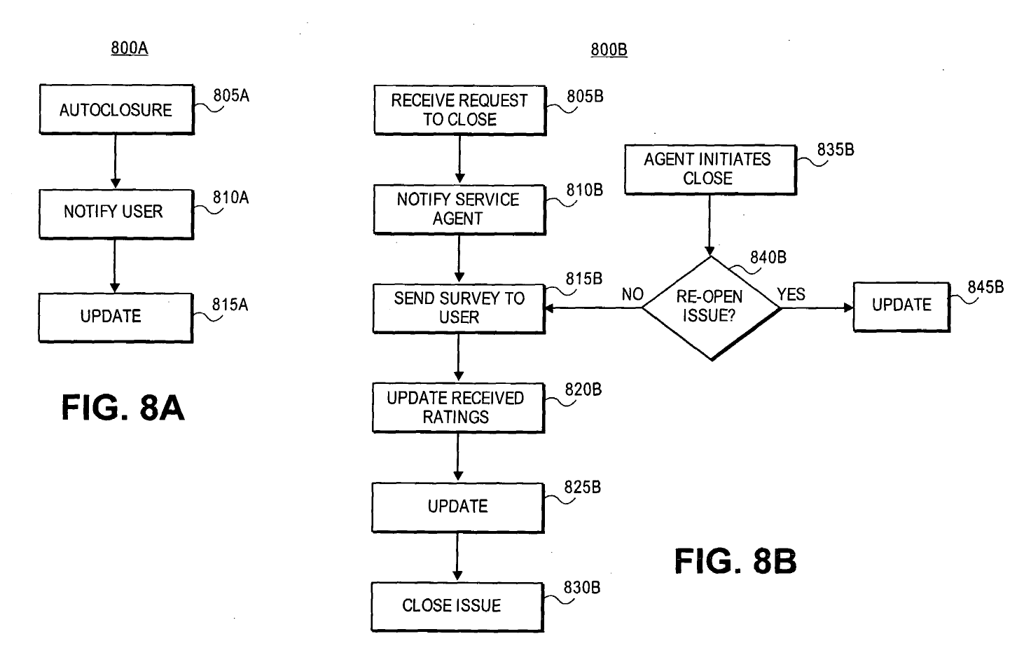

FIG. 8A illustrates an exemplary auto resolution flow diagram 800A implemented by the web ticketing system 315 in accordance with yet another embodiment. As shown in FIG. 8A, the web ticketing system 315 can initiate an auto-closure of a web ticket, in step 805A. As previously described, the web ticketing system 315 can maintain a queue or buffer of outstanding web tickets. The web ticketing system 315 can periodically check the status of each web ticket to ensure that the issues are being resolved according to SLA requirements. If the queued web ticket exceeds a predetermined threshold (for example, inactivity for six weeks), the web ticketing system 315 can be configured to initiate closing the ticket.

In step 810A, the web ticketing system 315 can be configured to notify the user of the closing of the web ticket. For example, the web ticketing system 315 can send an electronic message (electronic mail, instant message, etc.) to inform the user that the web ticket is being closed.

In step 815A, the web ticketing system 315 can be configured to implement the update flow diagram 600 shown in FIG. 6 to update the closing of the web ticket.

FIG. 8B depicts a customer and service agent resolution flow diagram 800B implemented by the web ticketing system 315 in accordance with yet another embodiment. As shown in FIG. 8B, the user can initiate a close of web ticket, in step 805B. For example, the user can access the help desk home page GUI which can contain a link to close an existing web ticket.

When the user activates the link, the web ticketing system 315 can be configured to notify the assigned service agent that the user is requesting a close of the web ticket, in step 810B.

In step 815B, the web ticketing system 315 can be configured to transmit a predetermined survey to the user. The survey can determine the user satisfaction with the overall support system as well as request for additional improvements or comments.

In step 820B, the web ticketing system 315 can receive the completed survey or, after a period of time for response, mark the survey as incomplete, the web ticketing system 315 can receive updated ratings based on the survey. If the survey was marked incomplete, a non-rating is updated to the ratings.

In step 825B, the web ticketing system 315 can be configured to perform an update flow diagram 600 shown in FIG. 6 to update the received ratings for the web ticket. Subsequently, the web ticket system 315 can close the ticket in step 830B.

A service agent can also initiate a close, in step 835B. More specifically, the service agent may have resolved the issue for the user and is required to closed to the issue according to SLA rules. Accordingly, the service agent can initiate the close within the web ticketing system 315.

In step 840B, the web ticketing system 315 can be configured to query the service agent whether or not to re-open the issue. More specifically, the web ticketing system 315 can invoke the user interface module to generate an issue query GUI that requests the service agent to re-open the technical issue by activating a GUI widget or to continue with the close by activating a second GUI widget.

If the service agent selects to re-open the issue, the web ticketing system 315 can be configured to perform the update flow diagram 600 shown in FIG. 6 to update the status of the web ticket as being reopened, in step 845B.

Otherwise, if the service agent elects to close the issue, the web ticketing system 315 can proceed to the processing associated with step 815B and its following steps.

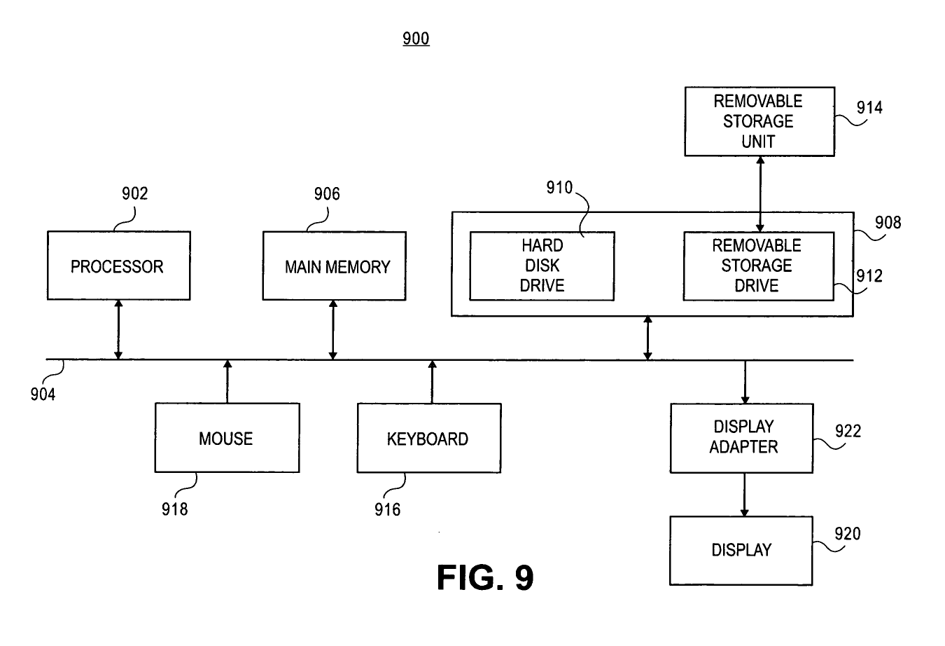

FIG. 9 illustrates an exemplary block diagram of a computing platform 900 where an embodiment may be practiced. The functions of the consolidated help desk 120 may be implemented in program code and executed by the computing platform 400. The consolidated help desk 120 may be implemented in computer languages such as PASCAL, C, C++, JAVA, etc.

As shown in FIG. 9, the computer system 900 includes one or more processors, such as processor 902 that provide an execution platform for embodiments of the consolidated help desk 120. Commands and data from the processor 902 are communicated over a communication bus 904. The computer system 900 also includes a main memory 906, such as a Random Access Memory (RAM), where the consolidated help desk 120 may be executed during runtime, and a secondary memory 908. The secondary memory 908 includes, for example, a hard disk drive 910 and/or a removable storage drive 912, representing a floppy diskette drive, a magnetic tape drive, a compact disk drive, etc., where a copy of a computer program embodiment for the consolidated help desk 120 may be stored. The removable storage drive 912 reads from and/or writes to a removable storage unit 914 in a well-known manner. A user interfaces with the consolidated help desk 120 with a keyboard 916, a mouse 918, and a display 920. The display adapter 922 interfaces with the communication bus 904 and the display 920. The display adapter 922 also receives display data from the processor 902 and converts the display data into display commands for the display 920.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of providing collaborative support for a service portal, the method comprising:
providing a plurality of products on the service portal, each product associated with a respective vendor;
receiving a set of selection of products based on the plurality of products;
determining a set of support resources for the set of selected products; and
applying a single service level agreement to the set of selected products, wherein a first product is associated with a first vendor and a second product is associated with a second vendor.

2. The method of claim 1, further comprising:
receiving an issue in the service portal in accordance with the single service level agreement; and
instantiating a ticket configured to track the issue in response the receipt of the issue in the service portal.

3. The method of claim 2, further comprising determining a severity level for the issue.

4. The method of claim 3, further comprising attempting to resolve the issue with knowledge resources of the service portal.

5. The method of claim 4, further comprising notifying a sender of the issue an issue resolution message in response to the issue being resolved by the resources of the service portal.

6. The method of claim 4, further comprising escalating the severity level to the highest level in response to the issue not being resolved by the knowledge resources of the service portal.

7. The method of claim 6, further comprising collaborating with the respective vendor of a product that generated the issue to resolve the issue.

8. The method of claim 7, further comprising notifying a sender of the issue an issue resolution message in response to the issue being resolved.

9. A system for collaborative support for a service portal, the system comprising:
a web-ticketing system configured to manage technical issues, wherein a ticket is generated for each new technical issue received; and
a manager module configured to be coupled with the web-ticketing system and the knowledge library and is configured to execute a single service level agreement for a plurality of products being sold on the service portal, each product being associated with a respective vendor and the single service level agreement specifying required service times and services, wherein the manager module is configured to invoke the web-ticketing system to generate a ticket in response to a received technical issue associated with a purchased product from the plurality of products and to generate an update message in response to the ticket being assigned to an agent according to the single service level agreement.

10. The system of claim 9, further comprising a knowledge library further comprising a knowledgebase and a community forum, the community forum configured to receive questions from users and to post answers to the questions from a community of registered users, wherein the manager module is configured to generate the update message as being resolved in response to the agent resolving the issue by one of searching the knowledgebase and posting the technical issue to the community forum according to the single service level agreement.

11. The system of claim 10, wherein the manager module is configured to determining a severity level for the issue.

12. The system of claim 11, wherein the manager module is configured to notify a sender of the technical issue an issue resolution message in response to the issue being resolved by the resources of the service portal according to the single service level agreement.

13. The system of claim 11, wherein the manager module is configured to escalate the severity level to the highest level in response to the issue not being resolved by the knowledge resources of the service portal according to the single service level agreement.

14. The system of claim 13, wherein the manager module is configured to determine the respective vendor of the purchased product and notifying the agent of the respective vendor according to the single service level agreement.

15. The system of claim 14, wherein the manager module is configured to notify the sender of the technical issue an issue resolution message in response to the issue being resolved by collaboration between the agent and the vendor according to the single service level agreement.
